(19) United States
(12) Patent Application Publication
(10) Pub. No.: US 2025/0040492 A1
(43) Pub. Date: Feb. 6, 2025

(54) REGULATED-ENVIRONMENT INCUBATOR FOR EFFICIENT GROWTH OF SAFFRON OR OTHER PLANTS

(71) Applicant: Saffron Tech Ltd., MavkiIm (IL)

(72) Inventors: Michael MAMAN, Hod-HaSharon (IL); Zvi OR-BACH, Hod-HaSharon (IL)

(73) Assignee: Saffron Tech Ltd., MavkiIm (IL)

(21) Appl. No.: 18/926,375

(22) Filed: Oct. 25, 2024

Related U.S. Application Data
(62) Division of application No. 17/453,470, filed on Nov. 3, 2021.
(60) Provisional application No. 63/111,656, filed on Nov. 10, 2020.

(51) Int. Cl. A01G 9/24

(52) U.S. Cl. CPC A01G 9/246

(57) ABSTRACT

A system for enabling plant growth in an automatic manner, the system including a system growing chamber; automatic transport mechanism; and a cooling sub-chamber, where an inner portion of the cooling sub-chamber is thermally insulated from an outside environment of the cooling sub-chamber, and where the cooling sub-chamber includes a refrigerating mechanism and temperature control electronics.

### RELATED APPLICATIONS

This application is a Division of U.S. patent application Ser. No. 17/453,470, filed on Nov. 3, 2021 which claims the benefit of U.S. Provisional Patent Application No. 63/111,656, filed on Nov. 10, 2020, and titled ENVIRONMENT REGULATION INCUBATOR FOR EFFICIENT GROWTH OF SAFFRON OR OTHER PLANT.

The contents of the above applications are all incorporated by reference as if fully set forth herein in their entirety.

### FIELD OF THE INVENTION

The present invention generally relates to plants, and more particularly to the environmental control within which the plants are grown.

### BACKGROUND OF THE INVENTION

Enclosure based agriculture is growing in popularity. A plant growing system should create a controlled artificial environment for indoor plant cultivation by preventing all interference of undesirable and random external climatic factors, and thus realize an effective environment for efficient cultivating of saffron or other plants. The well-structured Enclosure could support the best control conditions to provide the most successful production of high quality saffron or other plants, good yield, with the incomparable advantage of comprising a cultivation pattern.

### OBJECTIVES OF THE INVENTION

Accordingly, it is an object of the present invention to provide a system which is capable of applying an intelligent environment simulation for plant growth and development that involves optimal lighting conditions, temperature control, humidity control, nutrient regulation, and precise irrigation control with respect to the growing state of the saffron or other plants. Another object of the present invention to provide faster growth and phased growth to provide improved economics and quality for the plant.

### SUMMARY OF THE INVENTION

The present invention relates to a plant growing unit for enabling to grow plants in an automatic manner, comprising at least: a) a body having an interior volume defined by a front portion, two side panels, a top panel, a bottom panel, and a back panel;
b) at least one adjustable lighting assembly; c) an irrigation assembly that function as an aeroponic assembly and a hydroponic assembly; d) one or more sensors for obtaining data that represents the condition of the plant and of the growing environment within the interior volume; and e) a control unit configured to automatically control the adjustable lighting assembly and the irrigation assembly and to self-perform respective growing process operations.

According to an embodiment of the invention, the unit may further comprise a heating and cooling system as well as a circulation system to enable at least the control of the temperature and humidity within the interior volume.

According to an embodiment of the invention, the unit may further comprise a camera for at least providing visual data of the plant, thereby enabling inspection of the health condition of the plant and to monitor the growing process.

According to an embodiment of the invention, the control unit may be electrically connected to at least the adjustable lighting assembly, the irrigation assembly, and the sensors through respective power lines and/or through respective wireless signals.

According to an embodiment of the invention, the wireless signals may be provided by at least a Near Field Communication (NFC) protocol or by other wired or wireless other protocols.

According to an embodiment of the invention, the control unit may be configured to communicate with at least an external computer device, for example, such as a mobile device, via a wireless, or wired communication means.

According to an embodiment of the invention, the unit may further comprise at least one nutrition supply source, for example, such as in the form of a solution that includes one or more minerals that the plant needs.

According to an embodiment of the invention, the control unit may be configured to automatically control a fertilization process and to adjust and/or control the pH of the solution.

Additionally the enclosure may include a cooling chamber which may be designed to support lower than ambient temperatures as part of the Saffron or other plants growth regiment.

Additionally the chamber could include one or more robotic apparatus for low cost harvesting, and may include other robotic apparatus to perform other tasks such as, for example, weeding, planting, turning of the soil, adjust the pH via soil amendments, and so on.

### BRIEF DESCRIPTIONS OF THE DRAWINGS

Various other objects, features, and embodiments of the present invention will be understood and appreciated more fully from the following detailed description, taken in conjunction with the drawings in which:

FIG. 1 schematically illustrates a top perspective view of a plant growing chamber, according to an embodiment of the invention;

FIG. 2 schematically illustrates a side perspective view of a plant growing chamber, according to an embodiment of the invention;

FIG. 3 is a pictorial illustration of moveable shelves with plants;

FIG. 4 schematically illustrates growth stages vs. machine type; and

FIG. 5 schematically illustrates growth step transition between machines.

### DETAILED DESCRIPTION OF THE ILLUSTRATED EMBODIMENTS

Embodiments of the invention are described herein with reference to the drawing figures. Persons of ordinary skill in the art will appreciate that the description and figures illustrate rather than limit the invention and that in general the figures are not drawn to scale for clarity of presentation. Such skilled persons will also realize that many more embodiments are possible by applying the inventive principles contained herein and that such embodiments fall within the scope of the invention which is not to be limited except by the appended claims.

In the reproducible plant growing system, a plurality of substantially closed plant growth units, which may be distributed, are provided, in each of which plants are grown in an indoor controlled environment which may include air temperature and humidity, light intensity, wavelength and direction, and at least one irrigation solution including nutrient additives. Such a system has been proposed in the past such as been presented in PCT application WO 2017/103922, Chinese patents CN109220593, CN210094157, CN108990461, CN108990461, and a paper by Mohanty, Namrata P., et al. “Cultivation of Cash Crops under Automated Greenhouse using Internet of Things (IoT).” 2019 International Conference on Communication and Signal Processing (ICCSP). IEEE, 2019, the entire contents of all of the foregoing are incorporated herein by reference.

The proper conditions for effective growth of saffron include refrigerating the bulbs or corms for multiple days to lower than 10° C. Such cooling could increase the overall system costs if needed to be applied to the full chamber. An alternative approach is to construct a chamber within the enclosure in which the cooling takes place and to bring in groups of bulbs or corms for the cooling step. The bulbs could then be moved out and a new group could be brought in. The group that finished the cooling phase can than complete its growth and sequentially a harvest. The harvesting phase could use a specially designed robotic apparatus to further increase system efficiency.

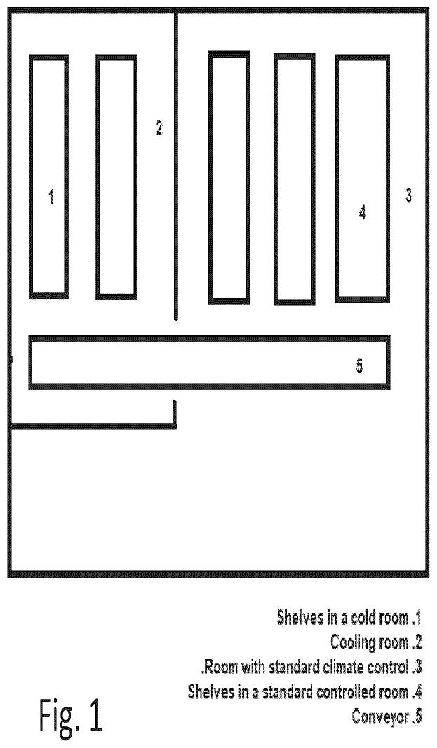

As illustrated in top-view block illustration FIG. 1, a Room with standard climate control 3 may include within it at least one Cooling Room 2 each with Cooling Room Shelves 1, Shelves in a Standard Controlled Room 4 and Conveyor 5. The Cooling Room 2 is well insulated to support efficient cooling for multiple days. Many Shelves in a Standard Controlled Room 4, which are moveable, may reside in the Room with standard climate control 3 for the many weeks of growth under a controlled environment. Conveyor 5, which is controlled by the system computer (not shown), may be commanded to bring a few selected Cooling Room Shelves 1 into the Cooling Room 2 for a cooling phase.

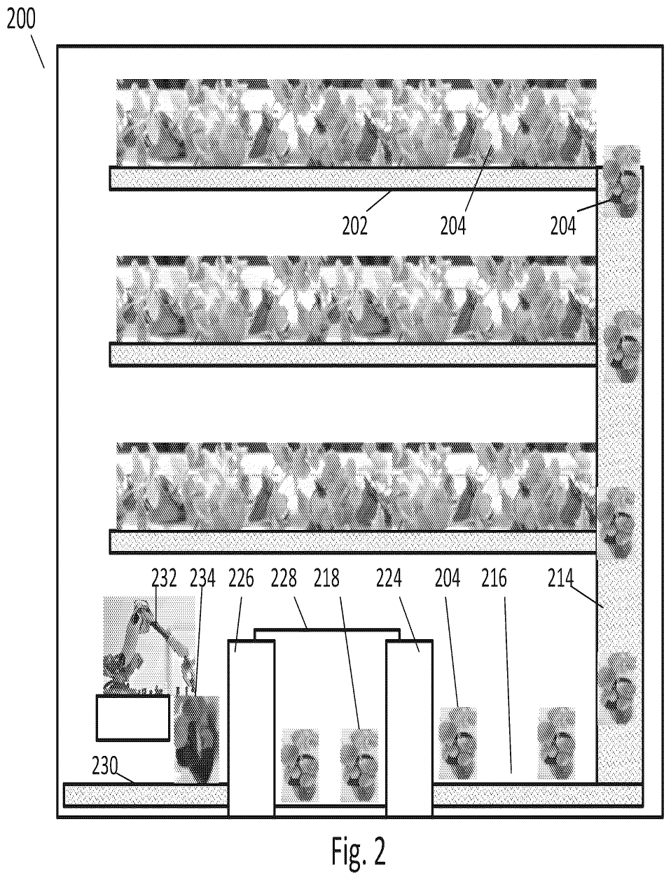

As illustrated in side-view block illustration FIG. 2 alternative Room with standard climate control 200 may include at least one cooling chamber 228. The cooling chamber 228 is well insulated to support efficient cooling for multiple days. Cooling chamber 228 could include entrance double doors 224 to allow bringing in bulbs or corms at a reduced cooling loss. It could also include exit double doors 226 to allow taking out plants at a reduced cooling loss. Entrance double door 224 and exit double door 226 may operate to save cooling losses by being interlocked with each other as well as being interlocked within each double door itself so that only one door is open at any moment.

Tray conveyor 202 is controlled by the system computer (not shown) to bring selected plants 204 onto a collecting conveyor 216 after passing 206 thru elevator 214. Then the selected plants 204 are moved into the cooling chamber 228 through the entrance double door 224. Once ready the cooled plants 218 could be moved out through the exit double doors 226.

Once the grown plants 234 are ready to be harvested, they could be moved from the harvesting conveyor 230 by the robotic apparatus 232 for harvest shipping or storage (not shown).

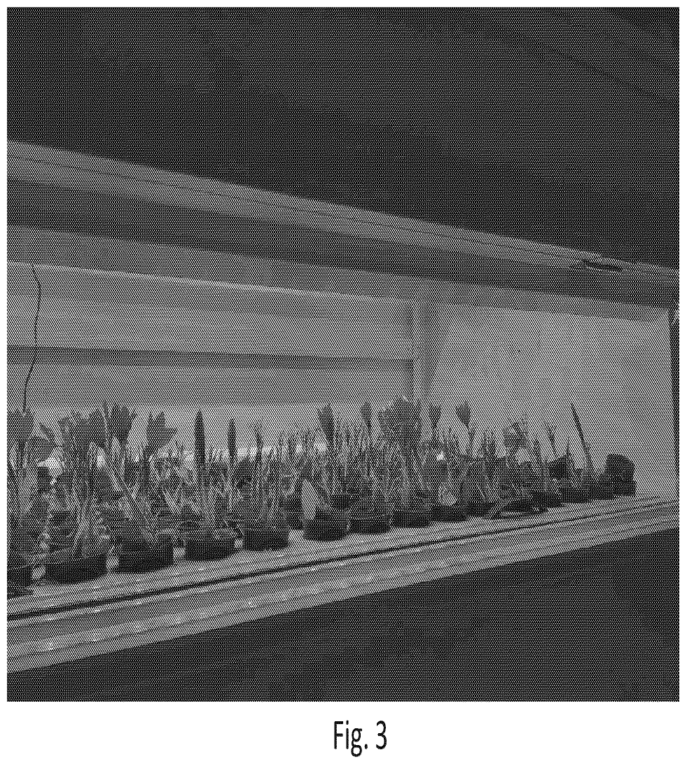

FIG. 3 is a pictorial illustration of moveable shelves with plants according to an alternative embodiment.

An alternative approach may include the following: the Bulbs or Corms could be planted in trays and be promoted to flower by exposure to 17° C. For the benefit of more simple robotic harvesting hysteranthous flowering habit could be done by the mentioned exposure without or limited irrigation. After flowering, the depletion of mother corm and the initiation of daughter corm will be induced by a period of cold temperature such as 8-12° C., average, for four weeks. An alternative could be colder temperature for shorter time such as temperature such as 3-4° C. for one week. Thereafter, a period of ˜60 days in temperatures such as 17-24° C., average, could promote vegetative growth and assimilation. Dormancy could be promoted by the warmer condition with temperature such as 24-30° C. for 14-30 days with the stop of the irrigation. Curing and flower initiation and differentiation will occur in storage (no light or irrigation is needed) under temperature such as 23-25° C. for approximately 50 days. Such curing and flower initiation and differentiation has been presented by at least Molina, R. V., et al. “The effect of time of corm lifting and duration of incubation at inductive temperature on flowering in the saffron plant (Crocus sativus L.).” Scientia horticulture 103.1 (2004): 79-91; Molina, Rosa V., et al. “Flower Formation in the Saffron Crocus (Crocus sativus L). The Role of Temperature.” Acta Horticulture (2004): 39-48; and by Plessner, Ora, et al. “Effects of temperature on the flowering of the saffron crocus (Crocus sativus L.): Induction of Hysteranthy.” Israel Journal of Plant Sciences 38.1 (1989): 1-7., the entire contents of all of the foregoing are incorporated herein by reference.

Saffron has an annual life cycle, starting with a mother corm, flower and foliage growth, production of daughter corms and two stages of dormancy (endodormancy and ecodormancy). Each stage has its own environmental condition demands for best performance and may be influenced by temperature, illumination, humidity and chemicals or even mechanical conditions. In order to adjust the saffron growth to an indoor facility, and alongside with automation, the growth could be divided into four stages, each of which could have its special conditions and could be done in a different machine, and which is could be designed to be most suitable for it. Separating the plant stages into different machines will allow the farmer to:

Generate a useful pipeline for factory production, in which the saffron flowers (and especially the stigma) supply could be issued according to a predetermined schedule, with backup storage and could be independent of climate and make it possible to use dedicated automation machinery to reduce labor demand and assure best preparation for the next stage in the growth cycle.

The four stages are:

Flowering-A hysteranthous flowering, in which flowers grow before the leaves grow. This step is expected to take place within 2-6 weeks, and its most dominant trigger is a chilled temperature of approximately 17° C.

Vegetative-foliage growth and daughter generation and creation of meredith buds. This process begins with a short cooling period of approximately 5° C. for approximately 2 weeks. Lowering the temperature should help with reducing the number of daughter corm, so in the end each daughter corm will gain enough biological material. The end of this period will be triggered by raising the environment temperature, to initiate dormancy.

Dormancy (endodormancy—dormancy controlled by internal factors).

Differentiation 25° C. (ecodormancy—where the plant show no phenotypic growth, caused by unfavorable conditions)

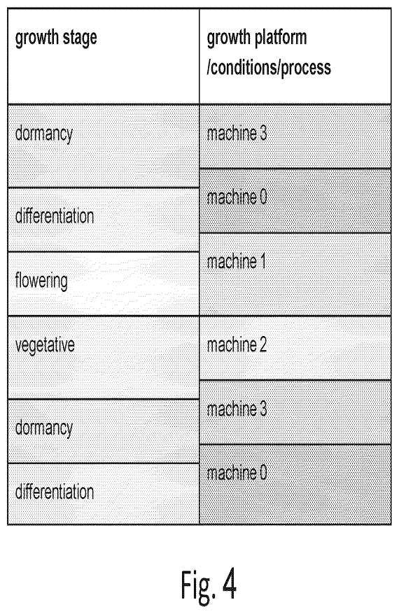

Since the different growth stages have different environmental requirements, and could take different time lengths for each plant, an effective system design could designate dedicated and properly designed growing machines assigned for each of these stages. It could be a more improved overall system if these machine operations are synchronized to provide the proper growth stages, and machine operation (such could be called an optimal pipe-line). While the machines are correlated with the particular stage of the growth, the transition between them might overlap growth stage transitions, such as is illustrated in FIG. 4.

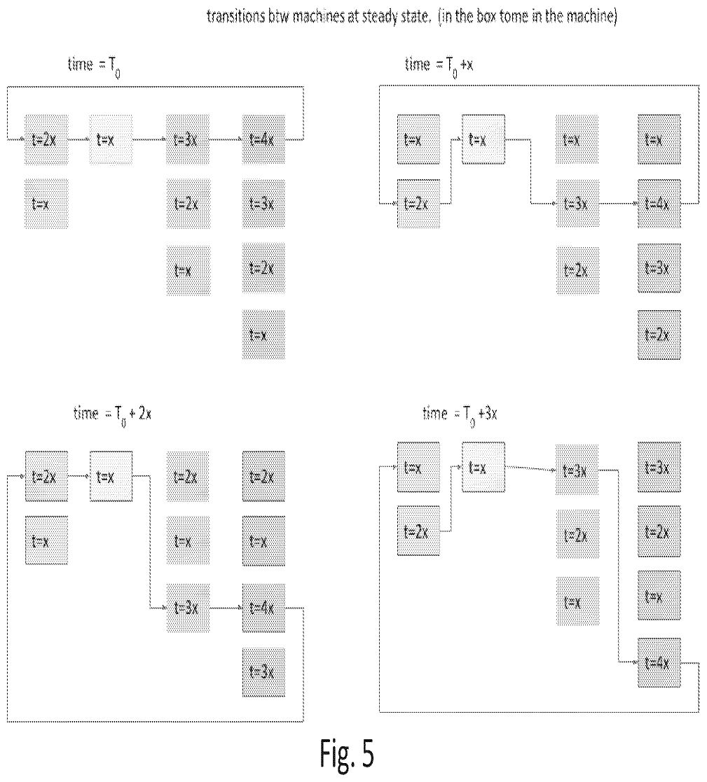

The number of machines needed for each type is determined by the ratio of the shortest machine-related process and the specific type process length, and can be calculated such as is illustrated in FIG. 5.

As an example the system could have 4 different machines/operational modes:
Machine 0—mostly for dormancy stages-no requirement for light or irrigation. It could include some environment control such as temperature, humidity and gas controls.
Machine 1—mostly for flowering.
Machine 2—specific cold treatment.
Machine 3—mostly designated for the vegetative stage, in which the daughter corms are produced.

It will also be appreciated by persons of ordinary skill in the art that the invention is not limited to what has been particularly shown and described hereinabove. For example, the functions to control the plant growing unit as described herein may be performed by executable code and instructions stored in a computer readable medium and running on one or more processor-based systems that can be part of the control unit as well as in a remote station. Those skilled in the art will appreciate that the invention may be practiced with different computer system configurations, including, multiprocessor systems, microprocessor-based or programmable consumer electronics, minicomputers, servers, cloud computing, mobile smartphones, and the like.

As will be appreciated by the skilled person the arrangement described in the figures results in a system which is capable of applying an intelligent environment simulation for plant growth and development that involves optimal lighting conditions and irrigation with respect to the growing state of the plant.

All the above description and examples have been given for the purpose of illustration and are not intended to limit the invention in any way. Many different mechanisms, methods of analysis, electronic and logical elements can be employed, all without exceeding the scope of the invention.

What is claimed is:

1. A method of growing saffron plants indoor, the method comprising:
(a) allowing mother corms of said saffron plants to flower so as to obtain flowering plants;
(b) harvesting said flowering plants; and subsequently
(c) exposing said mother corms to a temperature of 8-12° C. so as to induce initiation of daughter corms;
(d) inducing in said daughter corms vegetative growth at a temperature of 17-24° C. to obtain foliating plants;
(e) inducing dormancy in said foliating plants at a temperature of 24-30° C. and water deprivation so as to obtain dormant plants;
(f) exposing said dormant plants to light and water deprivation, to induce curing and flower initiation of said daughter corms.

2. The method of claim 1, performed in an automatic system for indoor cultivation.

3. The method of claim 2, wherein said automatic system features a plurality of units each featuring a controlled environment according to growth stage of said saffron plants and wherein transition of said saffron plants between said plurality of units is according to said growth stage of said saffron plants and wherein said growth stage of said saffron plants in each of said plurality of units is synchronized.

4. The method of claim 3, wherein at least one unit of said plurality of units comprises one or more sensors for obtaining data that represents a condition of the saffron plants and of growing environment.

5. The method of claim 4, wherein said at least one unit comprises a heating and cooling system and a circulation system to enable at least the control of the temperature and humidity within an interior volume of said at least one unit.

6. The method of claim 4, wherein said at least one unit comprises a camera for at least providing visual data of said saffron plants, thereby enabling inspection of health condition of said saffron plants and to monitor growing process.

7. The method of claim 2, comprising a robotic apparatus for said harvesting.

8. The method of claim 2, wherein said saffron plants are planted in trays positioned on automatic moveable shelves.
